(19) United States
(12) Patent Application Publication
(10) Pub. No.: US 2026/0119976 A1
(43) Pub. Date: Apr. 30, 2026

(54) UPDATING TRAINING DATA

(71) Applicant: Arm Limited, Cambridge, Cambridgeshire (GB)

(72) Inventors: Ugo CASTORINA, Biot (FR); Damien Matthieu Valentin CATHRINE, Mougins (FR); Natalya BONDARENKO, Antibes (FR); Geoffray Matthieu LACOURBA, Nice (FR)

(21) Appl. No.: 18/933,021

(22) Filed: Oct. 31, 2024

(51) Int. Cl. G06N 20/00

(52) U.S. Cl. CPC G06N 20/00

(57) ABSTRACT

There is provided an apparatus, a system, a chip containing product, a method, and a computer-readable medium. The apparatus comprises training storage circuitry to store training entries, each comprising training data indicative of a trigger operation and one or more relationships between the trigger operation and operations observed subsequent to the trigger operation. The apparatus comprises training circuitry to monitor operations during a training period having a predefined training duration, and responsive to observation of the trigger operation indicated in a training entry, to update the training data in the training entry. The training storage circuitry is configured to maintain update information associated with each training entry indicating whether that training entry has been updated during the training period. The training circuitry is responsive to a determination that the update information for a given training entry meets a predetermined condition, to truncate the training period for the given training entry.

### TECHNICAL FIELD

The present invention relates to data processing. More particularly the present invention relates to an apparatus, a system, a chip containing product, a method, and a computer-readable medium.

### BACKGROUND

Some apparatuses are provided with training storage circuitry to store training entries suitable for generation of speculative operations by a predictive structure in response to observation of a trigger operation.

### SUMMARY

According to a first aspect of the present techniques there is provided an apparatus comprising:
training storage circuitry configured to store one or more training entries, each of the one or more training entries comprising training data indicative of a trigger operation and one or more relationships between the trigger operation and operations observed subsequent to the trigger operation, wherein the training data is suitable to be used for generation of speculative operations by a predictive structure in response to observation of the trigger operation; and
training circuitry configured to monitor operations during a training period having a predefined training duration, and responsive to observation of the trigger operation indicated in a training entry of the one or more training entries, to update the training data in the training entry based on the monitored operations,
wherein:
the training storage circuitry is configured to maintain update information associated with each one of the one or more training entries and indicative of whether that one of the one or more training entries has been updated during the training period; and
the training circuitry is responsive to a determination that the update information associated with a given training entry of the one or more training entries meets a predetermined condition, to truncate the training period for the given training entry.

According to a second aspect of the present techniques there is provided a system comprising:
the apparatus according to the first aspect, implemented in at least one packaged chip;
at least one system component; and
a board,
wherein the at least one packaged chip and the at least one system component are assembled on the board.

According to a third aspect of the present techniques there is provided a chip-containing product comprising the system according to the second aspect, wherein the system is assembled on a further board with at least one other product component.

According to a fourth aspect of the present techniques there is provided a method comprising:
storing one or more training entries, each of the one or more training entries comprising training data indicative of a trigger operation and one or more relationships between the trigger operation and operations observed subsequent to the trigger operation, wherein the training data is suitable to be used for generation of speculative operations by a predictive structure in response to observation of the trigger operation;
monitoring operations during a training period having a predefined training duration, and in response to observation of the trigger operation indicated in a training entry of the one or more training entries, updating the training data in the training entry based on the monitored operations;
maintaining update information associated with each one of the one or more training entries and indicative of whether that one of the one or more training entries has been updated during the training period; and
in response to a determination that the update information associated with a given training entry of the one or more training entries meets a predetermined condition, truncating the training period for the given training entry.

According to a fifth aspect of the present techniques there is provided a non-transitory computer-readable medium storing computer-readable code for fabrication of an apparatus comprising:
training storage circuitry configured to store one or more training entries, each of the one or more training entries comprising training data indicative of a trigger operation and one or more relationships between the trigger operation and operations observed subsequent to the trigger operation, wherein the training data is suitable to be used for generation of speculative operations by a predictive structure in response to observation of the trigger operation; and
training circuitry configured to monitor operations during a training period having a predefined training duration, and responsive to observation of the trigger operation indicated in a training entry of the one or more training entries, to update the training data in the training entry based on the monitored operations,
wherein:
the training storage circuitry is configured to maintain update information associated with each one of the one or more training entries and indicative of whether that one of the one or more training entries has been updated during the training period; and
the training circuitry is responsive to a determination that the update information associated with a given training entry of the one or more training entries meets a predetermined condition, to truncate the training period for the given training entry.

### BRIEF DESCRIPTION OF THE DRAWINGS

The present invention will be described further, by way of example only, with reference to configurations thereof as illustrated in the accompanying drawings, in which:

FIG. 1 schematically illustrates an apparatus according to some configurations of the present techniques;

FIG. 2 schematically illustrates an apparatus according to some configurations of the present techniques;

FIG. 3 schematically illustrates an apparatus according to some configurations of the present techniques;

FIG. 4 schematically illustrates a training entry according to some configurations of the present techniques;

FIG. 5 schematically illustrates an apparatus according to some configurations of the present techniques;

FIG. 6 schematically illustrates an apparatus according to some configurations of the present techniques;

FIG. 7 schematically illustrates a sequence of steps according to some configurations of the present techniques;

FIG. 8 schematically illustrates a sequence of steps according to some configurations of the present techniques; and

FIG. 9 schematically illustrates a system and a chip containing product according to some configurations of the present techniques.

### DESCRIPTION OF EXAMPLE CONFIGURATIONS

Before discussing the configurations with reference to the accompanying figures, the following description of configurations is provided.

According to some configurations of the present techniques there is provided an apparatus comprising training storage circuitry configured to store one or more training entries. Each of the one or more training entries comprises training data indicative of a trigger operation and one or more relationships between the trigger operation and operations observed subsequent to the trigger operation. The training data is suitable to be used for generation of speculative operations by a predictive structure in response to observation of the trigger operation. The apparatus also comprises training circuitry configured to monitor operations during a training period having a predefined training duration, and responsive to observation of the trigger operation indicated in a training entry of the one or more training entries, to update the training data in the training entry based on the monitored operations. The training storage circuitry is configured to maintain update information associated with each one of the one or more training entries and indicative of whether that one of the one or more training entries has been updated during the training period. The training circuitry is responsive to a determination that the update information associated with a given training entry of the one or more training entries meets a predetermined condition, to truncate the training period for the given training entry.

Some apparatuses are provided with predictive structures that are arranged to speculatively perform one or more operations in response to a trigger operation. In order to identify a suitable trigger operation and suitable operations to perform in response to the trigger, the apparatus is provided with training circuitry to monitor operations, for example, operations performed by processing circuitry, and to update training data stored in training storage circuitry. The training data comprises an indication of a trigger operation, i.e., an operation that occurs during execution of instructions by processing circuitry, and an indication of one or more relationships between the trigger operation and one or more operations that are expected to be performed subsequent to the trigger operation. The one or more operations may be operations that have previously been observed as having been performed subsequent to a previous occurrence of the trigger operation or may be operations that are predicted to occur after a previously observed or predicted trigger based on observation of one or more previously occurring access patterns that, when extrapolated, predict the occurrence of the trigger operation and the one or more subsequent operations. The one or more relationships may be variously defined and may include, for example, a stride distance between an address accessed during the trigger operation and one or more addresses accessed in the further operations, and/or one or more producer-consumer relationships between the trigger operation and the one or more subsequent operations. The trigger operation can be any type of operation, for example, the trigger operation may be identified by receipt of a program counter value or an instruction pointer indicating a particular instruction. Alternatively, or in addition, the trigger operation may be a specific type of operation and/or an operation accessing a certain address or utilising a particular subset of the processing circuitry. In some configurations the trigger operation is a program counter value of a load instruction previously identified as a potential producer load instruction, i.e., a load instruction which returns a base pointer from which one or more addresses to be used in one or more corresponding consumer loads may be derived. The relationships may each comprise an offset to be combined with the base pointer loaded by the producer load to form the addresses.

In order to ensure that the training data is up to date and likely to be predictive of current workloads, the training circuitry performs training to update the training entries based on monitored operations. This training occurs during a training period which has a predefined duration which may be hardwired into the training circuitry or defined in a control register. The inventors have recognised that there are some situations in which the use of a training period with a predefined duration may reduce responsiveness of a prefetcher. For example, in some use cases a particular training entry may be trained early in the training period, i.e., so that the particular training entry has been trained before the end of the predefined duration. In such a scenario, continuing to train the particular training entry may prevent other training entries from being trained and potentially results in an underutilisation of the training circuitry. As an alternative example use case, the workload of the processing circuitry during the training period of the particular training entry may be different to the workload on which the training entry was predicted. As a result, the trigger operation and the operations observed subsequent to the trigger operation may not be observed during the predefined duration. As a result, the training entry may not be trained during the training period again resulting in an underutilisation of the training circuitry.

The training storage circuitry is arranged to maintain update information. The update information is associated with each of the training entries and indicates whether the training entry with which it is associated has been updated during the training period. The update information may be encoded into the training entry or stored in additional storage elements comprised within the storage elements that store the training entry. Alternatively, one or more additional storage structures may be provided to store the update information in association with the storage elements used to store the training entry. The update information is updated by the training circuitry during the training period and, when the training circuitry identifies that the update information meets a predetermined condition, the training circuitry truncates the training period. In other words, the update information is provided to allow the training circuitry to maintain and utilise information relating to whether or not each training entry is an entry for which the training period should continue or should be truncated. Truncating the training period for the given training entry means causing the training period for the given training entry to end prior to a point at which that training period would have ended if the training period was to continue for the predefined duration. In other words, truncating the training period for the given training entry causes the training period for the given training entry to be cut short. Where multiple training entries are being trained at a given time, truncating the training period for the given training entry may not affect the training period for the other entries being trained. The training circuitry may therefore truncate the training period for the given training entry and allow another training entry to continue training. Truncating the training period in this way allows training for training entries that are either not being trained or that have finished their useful training to be stopped reducing the resource usage of the training circuitry.

The update information may be variously defined and in some configurations the update information comprises, for each one of the one or more training entries, an update indication identifying which of the one or more relationships indicated in that one of the one or more training entries have been updated during the training period. The update information may, at the start of the training period, be initialised to indicate that none of the relationships have been updated during the training period. The control circuitry can then modify the update information to indicate that a particular one of the relationships indicated in the one or more training entries has been updated when an update is made to that relationship.

In some configurations the predetermined condition is met for the given training entry when the update information for the given training entry indicates that a predetermined number of the one or more relationships indicated in the given training entry have been updated during the training period. The predetermined number may comprise all of the one or more relationships. Alternatively, the predetermined number may comprise a subset of the one or more relationships. In this way, the update information can be used to determine which fraction of the relationships have been updated and can prevent the training circuitry devoting resources to monitoring operations when, for example, all of the relationships have already been trained.

Whilst the update information may be encoded in any manner, in some configurations the update indication is encoded as an additional bit for each of the one or more relationships. The additional bits may be provided as having a one to one correspondence to the one or more relationships with each additional bit being associated with a respective one of the one or more relationships. The additional bits may be initialised to a first value (one of a logical zero or a logical one). When the respective relationship is updated, the additional bit can then be set to a second value (the other of a logical zero or a logical one). The predetermined condition may be considered to be met when the predetermined number of the additional bits takes the second value. Alternatively, the additional bits may be encoded such that whether each of the one or more relationships has been updated during the training period can be derived by applying a logical function to the set of additional bits.

In addition to, or as an alternative to, the update indication, in some configurations the update information comprises, for each one of the one or more training entries, update duration information indicative of a duration since a last update to one of the one or more relationships indicated in that one of the one or more training entries. The duration information may be initialised at the start of the training period and modified throughout the training period to indicate the duration (e.g., a number of received operations, a number of received clock cycles, or a number of events) since the last point at which the duration information was initialised. The duration information can then be reset (i.e., re-initialised) in response to an update to any one of the one or more relationships indicated in the training entry being updated. The training circuitry can therefore use the duration information to determine whether or not the relationships are being updated and, in the event that the duration information indicates that the relationships are not being updated, or have not been recently updated, can truncate the training period for that training entry.

In some configurations, for each of the one or more training entries the update duration information is encoded in a counter associated with that one of the one or more training entries. The update duration information can therefore be provided as a single counter for each entry. Initialising the update duration information may comprise setting the counter to an initial value (for example, the initial value may be zero or a maximum possible value of the counter). The counter may then be modified (e.g., incremented or decremented) over the duration of the training period and reset to the initial value when one of the one or more relationships is updated.

In some configurations the predetermined condition is met for the given training entry when the duration information meets or exceeds a duration threshold. The duration threshold may be a fixed threshold, for example, hardwired into the training circuitry. Alternatively, the duration threshold may be a variable threshold stored, for example, in a register associated with the training circuitry.

Whilst in some configurations the duration threshold may be defined on a per training entry basis, in some configurations the duration threshold is a global threshold that is common to the one or more training entries. The provision of a global threshold reduces the storage space required for the duration threshold.

In some configurations the duration threshold is modified in response to the predetermined condition being met. In other words, the duration threshold may be updated when a training period for a given training entry is truncated. Updating the duration threshold in this way provides a feedback mechanism to tune the threshold based on the conditions at the point that the given training entry is truncated.

In some configurations the duration threshold is updated based on an average number of relationships updated for each of the one or more training entries during the training period. For example, where the training period is being frequently truncated with none or only a subset of the relationships being updated, the threshold may be increased. On the other hand, if the training period is being truncated as a result of the duration threshold being met with all, or the majority, of the relationships being updated, then the duration threshold may be reduced.

In some configurations the duration threshold is initialised based on a micro-architectural parameter. For example, the duration threshold may be initialised based on the size of the reorder buffer (ROB) or based on a size of a storage structure configured to store data in for processing by the processing circuitry, e.g., a cache structure such as an L1 cache.

Whilst the trigger operation may be any operation, for example, a prediction of a branch instruction, in some configurations the trigger operation is a memory access operation and each of the one or more operations observed subsequent to the trigger operations are subsequent memory access operations. The predictive structure utilising the information in the training entries trained by the training circuitry may therefore be able to speculatively retrieve data (which may also include data representative of one or more instructions to be executed by processing circuitry) in advance of a point at which that data is required by processing circuitry.

In some configurations the predictive structure is a prefetching structure. For example, the prefetching structure may be an indirect prefetching structure or a pattern based prefetching structure.

In some configurations the apparatus comprises pattern history table storage circuitry configured to store a pattern history table, the pattern history table comprising a plurality of entries, wherein: the predictive structure is configured to generate the speculative operations based on at least one of the plurality of entries; and the training circuitry is configured to select one or more entries from amongst the plurality of entries to be stored in the training storage circuitry as the one or more training entries during each of a plurality of training periods. The plurality of entries stored in the pattern history table may exceed the number of entries stored in the training storage circuitry. The training circuitry may sequentially select entries of the pattern history table to be trained by the training circuitry. For example, in some configurations the training storage circuitry may store a single entry. In other configurations, the training storage circuitry may store two entries or four entries. On the other hand, the pattern history table may store a much larger number of entries, for example, 128 entries or 256 entries. By truncating the training period when the predetermined condition is met, the training circuitry may more rapidly work through the entries of the pattern history table resulting in an improved rate of training and a more representative set of patterns within the pattern history table.

Whilst the training duration may be defined in terms of a number of clock cycles, in some configurations the predefined training duration is defined in terms of a number of monitored operations. For example, where the monitored operations are memory accesses defined by program counter values of those memory accesses, the predefined duration may be expressed in terms of a number of monitored memory operations. As a result, the opportunity for training a given training entry is independent of a density of memory accesses within a particular segment of code being executed.

In some configurations updating the training data comprises at least one of: updating a confidence associated with one of the one or more relationships based on the operations observed subsequent to the trigger operation; and allocating a new relationship based on the operations observed subsequent to the trigger operation. The update information is therefore indicative of whether the relationships already present in a training entry have been updated and is indicative of whether any new relationships have been added to the training entry during the training period. Updating the confidence may comprise increasing a confidence when one of the relationships stored in the training entry is observed as part of the monitored operations. Allocating a new relationship may comprise evicting a previous relationship indicated in the training entry. Eviction of previous relationships may be carried out according to an eviction policy, for example, evicting a relationship having a lowest confidence.

Particular configurations will now be described with reference to the figures.

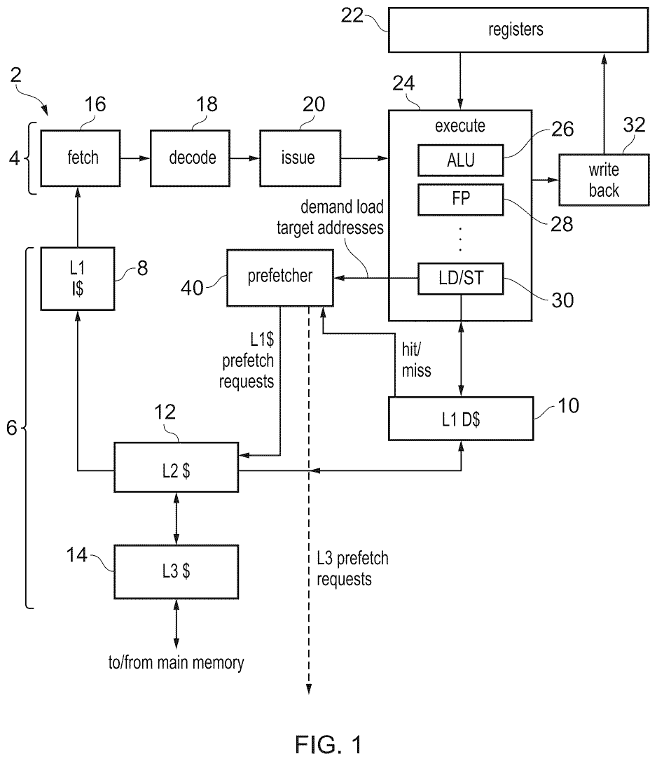

FIG. 1 illustrates an example of a data processing apparatus 2. The apparatus has a processing pipeline 4 for processing program instructions fetched from a memory system 6. The memory system in this example includes a level 1 instruction cache 8, a level 1 data cache 10, a level 2 cache 12 shared between instructions and data, a level 3 cache 14, and main memory which is not illustrated in FIG. 1 but may be accessed in response to requests issued by the processing pipeline 4. It will be appreciated that other examples could have a different arrangement of caches with different numbers of cache levels or with a different hierarchy regarding instruction caching and data caching (e.g. different numbers of levels of cache could be provided for the instruction caches compared to data caches).

The processing pipeline 4 includes a fetch stage 60 for fetching program instructions from the instruction cache 8 or other parts of the memory system 6. The fetched instructions are decoded by a decode stage 18 to identify the types of instructions represented and generate control signals for controlling downstream stages of the pipeline 4 to process the instructions according to the identified instruction types. The decode stage passes the decoded instructions to an issue stage 20 which checks whether any operands required for the instructions are available in registers 22 and issues an instruction for execution when its operands are available (or when it is detected that the operands will be available by the time they reach the execute stage 24). The execute stage 24 includes a number of functional units 26, 28, 30 for performing the processing operations associated with respective types of instructions. For example, in FIG. 1 the execute stage 24 is shown as including an arithmetic/logic unit (ALU) 26 for performing arithmetic operations such as add or multiply and logical operations such as AND, OR, NOT, etc. Also the execute unit includes a floating point unit 28 for performing operations involving operands or results represented as a floating-point number. Also the functional units include a load/store unit 30 for executing load instructions to load data from the memory system 6 to the registers 22 or store instructions to store data from the registers 22 to the memory system 6. Load requests issued by the load/store unit 30 in response to executed load instructions may be referred to as demand load requests discussed below. Store requests issued by the load/store unit 30 in response to executed store instructions may be referred to as demand store requests. The demand load requests and demand store requests may be collectively referred to as demand memory access requests. It will be appreciated that the functional units shown in FIG. 1 are just one example, and other examples could have additional types of functional units, or could have multiple functional units of the same type, or may not include all of the types shown in FIG. 1 (e.g. some processors may not have support for floating-point processing). The results of the executed instructions are written back to the registers 22 by a write back stage 32 of the processing pipeline 4.

It will be appreciated that the pipeline architecture shown in FIG. 1 is just one example and other examples could have additional pipeline stages or a different arrangement of pipeline stages. For example, in an out-of-order processor a register rename stage may be provided for mapping architectural registers specified by program instructions to physical registers identifying the registers 22 provided in hardware. Also, it will be appreciated that FIG. 1 does not show all of the components of the data processing apparatus and that other components could also be provided. For example, a branch predictor may be provided to predict outcomes of branch instructions so that the fetch stage 16 can fetch subsequent instructions beyond the branch earlier than if waiting for the actual branch outcome. Also a memory management unit could be provided for controlling address translation between virtual addresses specified by the program instructions and physical addresses used by the memory system.

As shown in FIG. 1, the apparatus 2 has a prefetcher 40 for analysing patterns of demand target addresses specified by demand memory access requests issued by the load/store unit 30, and detecting stride sequences of addresses where there are a number of addresses separated at regular intervals of a constant stride value. The prefetcher 40 uses the detected stride address sequences to generate prefetch load requests which are issued to the memory system 6 to request that data is brought into a given level of cache. The prefetch load requests are not directly triggered by a particular instruction executed by the pipeline 4, but are issued speculatively with the aim of ensuring that when a subsequent load/store instruction reaches the execute stage 24, the data it requires may already be present within one of the caches, to speed up the processing of that load/store instruction and therefore reduce the likelihood that the pipeline has to be stalled. The prefetcher 40 may be able to perform prefetching into a single cache or into multiple caches. For example, FIG. 1 shows an example of the prefetcher 40 issuing level 1 cache prefetch requests which are sent to the level 2 cache 12 or downstream memory and request that data from prefetch target addresses is brought into the level 1 data cache 10. Also the prefetcher 40 in this example can also issue level 3 prefetch requests to the main memory requesting that data from prefetch target addresses is loaded into the level 3 cache 14. The level 3 prefetch request may look a longer distance into the future than the level 1 prefetch requests to account for the greater latency expected in obtaining data from main memory into the level 3 cache 14 compared to obtaining data from a level 2 cache into the level 1 cache 10. In systems using both level 1 and level 3 prefetching, the level 3 prefetching can increase the likelihood that data requested by a level 1 prefetch request is already in the level 3 cache. However, it will be appreciated that the particular caches loaded based on the prefetch requests may vary depending on the particular circuit of implementation.

It would be readily apparent to the skilled person that a stride based prefetcher, such as the one described in relation to FIG. 1 is merely one example of a possible prefetcher. The prefetcher may, in some configurations, predict access patterns based on a producer-consumer relationship between two memory access instructions. The person of ordinary skill in the art would appreciate that the prefetch generation circuitry can be of any form and use any algorithm to generate the prefetch requests.

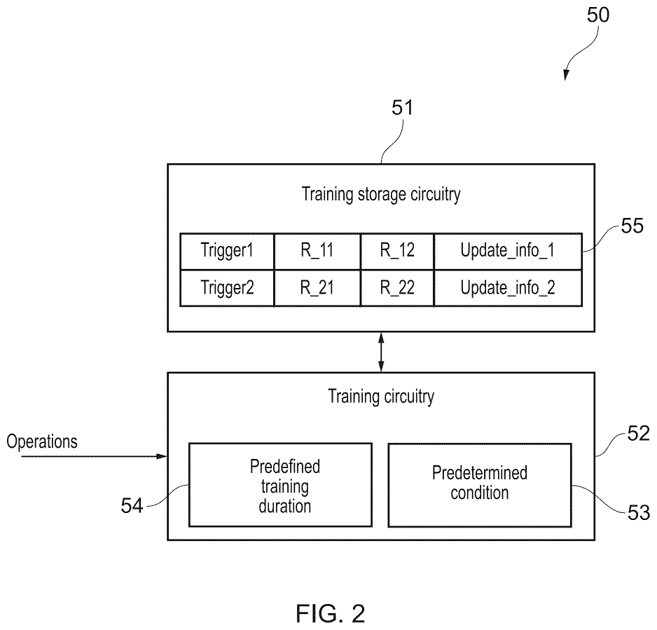

FIG. 2 schematically illustrates an apparatus 50 according to some configurations of the present techniques. The apparatus 50 is provided with training storage circuitry 51 and training circuitry 52. The training storage circuitry 51 includes storage for one or more training entries 55. The training entries 55 each identify a trigger operation and relationships between the trigger operation and one or more operations observed subsequent to the trigger operation. Each of the training entries is further provided with update information. In the illustrated configuration, the training storage circuitry 51 stores two training storage entries 55. The first one of the training storage entries 55 identifies a trigger operation, Trigger1, and relationships R_11 and R_12 which each identify a relationship between the operation Trigger1 and one or more further operations. The first one of the training storage entries 55 is provided with update information, Update_info_1. The second one of the training storage entries 55 identifies a trigger operation, Trigger2, and relationships R_21 and R_22 which each identify a relationship between the operation Trigger2 and one or more further operations. The second one of the training storage entries 55 is provided with update information, Update_info_2.

The training circuitry 52 is configured to perform training to update the training entries 55 in response to a monitored sequence of operations. The training circuitry is configured to perform the training for each of the entries over a training period having a predefined training duration 54. The predefined training duration is measured in terms of the monitored operations. Whilst training the training entries 55, the training circuitry is configured to determine whether the update information associated with each of the training entries 55 meets a predetermined condition 53. The training circuitry 52 is responsive to the update information for a given one of the training entries 55 meeting the predetermined condition 53 to truncate the training period for the given one of the training entries 55.

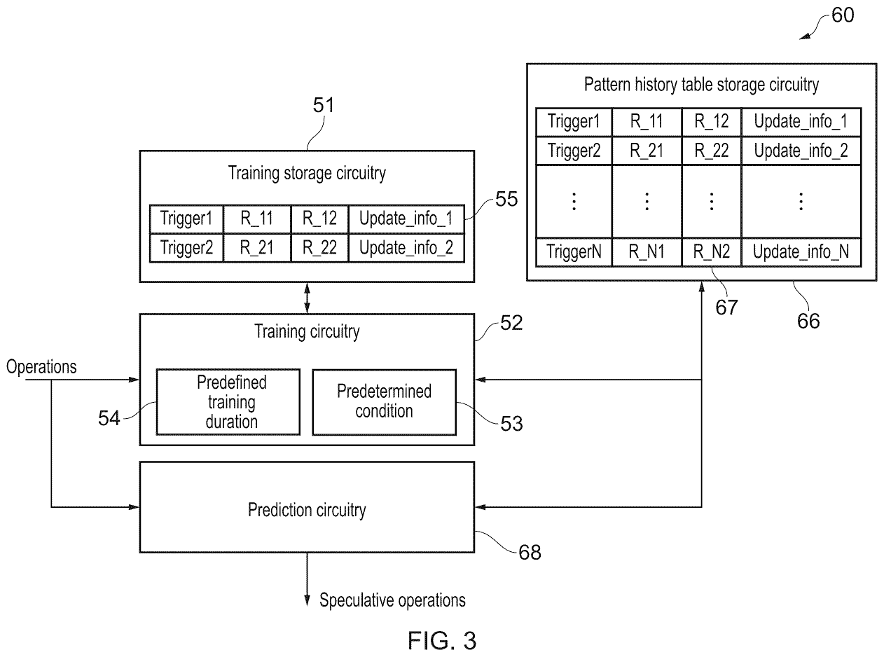

FIG. 3 schematically illustrates an apparatus 60 according to some configurations of the present technique. The apparatus 60 includes training storage circuitry 51 and training circuitry 52 as described in relation to FIG. 2. In addition, the apparatus 60 is provided with a pattern history table storage circuitry 66 and prediction circuitry 68. The pattern history table storage circuitry 66 stores a pattern history table 67 which comprises a plurality of entries. Each of the plurality of entries contains an indication of a trigger and relationships between the trigger and one or more operations observed subsequent to the trigger. The pattern history table 67 also includes update information associated with each of the plurality of entries. The pattern history table storage circuitry 66 is coupled to the prediction circuitry 68 which receives an indication of operations performed by processing circuitry associated with the apparatus 60. In response to receipt of an operation, the prediction circuitry 68 triggers the pattern history table storage circuitry 66 to perform a lookup in the pattern history table 67 based on the operation. Where the operation corresponds to a trigger in one of the entries in the patter history table 67, i.e., the lookup results in a hit in the pattern history table 67, the relationships stored in that entry are forwarded to the prediction circuitry 68. The prediction circuitry then performs one or more speculative operations based on the relationships received from the pattern history table 67.

The training circuitry 52 is configured to perform training for the training entries 55 currently stored in the training storage circuitry 51. When the training period is complete for one or more of the training entries 55, the one or more training entries 55 for which the training period is complete are stored in the pattern history table 67 and a next one or more entries from the pattern history table 67 are selected for training. As discussed, the training circuitry 51 may determine that the training period is complete for each of the training entries 55 when the predefined training duration 54 is complete or when the update information associated with that one of the training entries meets the predetermined condition 53. The training circuitry 52 is configured to reset the update information for each of the training entries at the beginning of the training period.

In some alternative configurations the pattern history table 67 may omit the update information. It will be readily apparent to the skilled person that additional metadata and/or additional relationships may be included in the entries of the pattern history table 67 and the training entries 55.

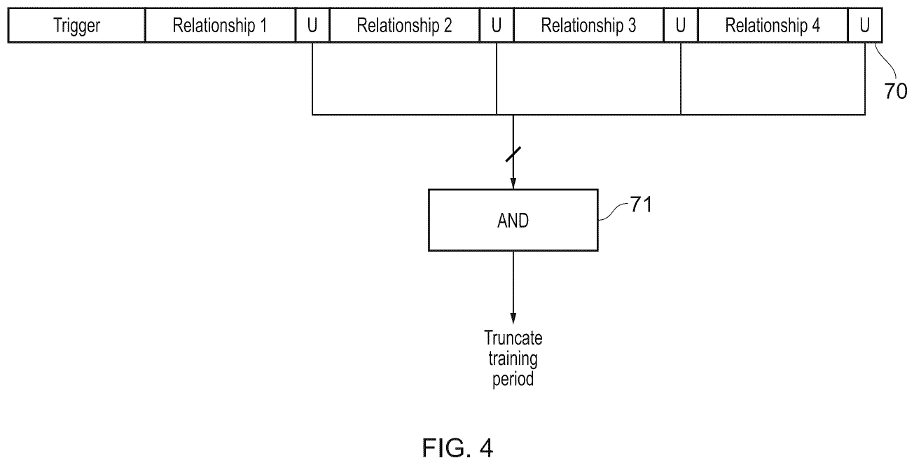

FIG. 4 schematically illustrates a format of a training entry 70 according to some configurations of the present techniques. The training entry 70 identifies a trigger and a plurality of relationships: Relationship 1, Relationship 2, Relationship 3, and Relationship 4. Each of the relationships is associated with a single update bit U. The single update bit U indicates whether that relationship has been updated during the training period. At the start of the training period the update bits are set to a logical zero. During training, when one of the relationships is trained, the update bit that is associated with the relationship being trained is updated to a logical 1. The training circuitry is configured to determine whether to truncate the training period based on values of the update bits. In particular, the training circuitry is provided with AND circuitry 71. The AND circuitry 71 receives each of the update bits as inputs and determines that the training period should be truncated when all of those update bits are set to a logical 1.

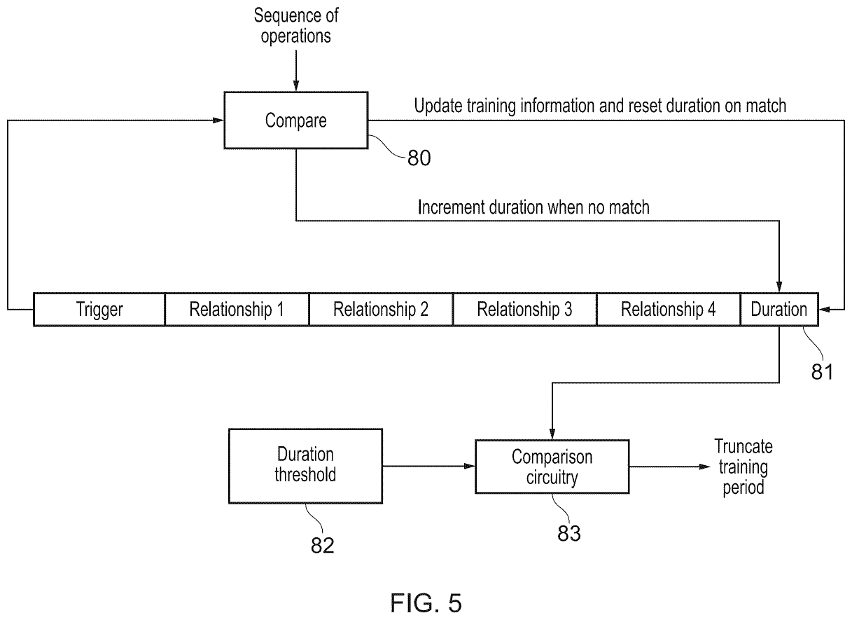

FIG. 5 schematically illustrates a format of a training entry 81 according to some configurations of the present techniques. The training entry 81 identifies a trigger and a plurality of relationships: Relationship 1, Relationship 2, Relationship 3, and Relationship 4. The training entry 81 also identifies duration information implemented as a counter to count a number of monitored operations since a last relationship was update. The training circuitry is configured to receive a sequence of operations which are compared against the relationships provided in the training entry 81. The comparison is performed by comparison circuitry 80 which triggers the duration to be incremented for each operation received that does not cause a relationship to be updated. The comparison circuitry 80 is responsive to an operation that causes one of the relationships in the training entry 81 to be updated to trigger that relationship to be updated and to reset the duration in the training entry 81. The training circuitry is configured to truncate the training period when it is determined that the duration indicated in the training entry 81 exceeds a duration threshold 82. The training circuitry is provided with comparison circuitry 83 which receives the duration from the training entry 81 and the duration threshold 82. The comparison circuitry is configured to trigger the truncation of the training period when the duration exceeds the duration threshold 82.

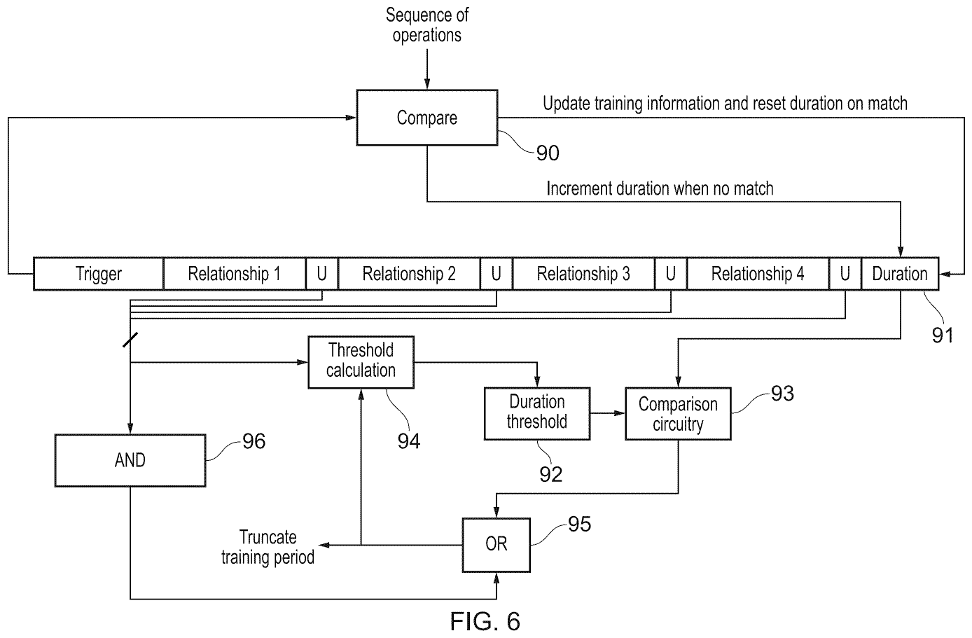

FIG. 6 schematically illustrates a format of a training entry 91 according to some configurations of the present techniques. The training entry 91 combines the update information described in relation to FIG. 4 and the update information described in relation to FIG. 5. In particular, the training entry 91 identifies a trigger and a plurality of relationships: Relationship 1, Relationship 2, Relationship 3, and Relationship 4. The training entry 81 also identifies duration information implemented as a counter to count a number of monitored operations since a last relationship was update. Each of the relationships is also associated with a single update bit U. The single update bit U indicates whether that relationship has been updated during the training period. At the start of the training period the update bits are set to a logical zero. During training, when one of the relationships is trained, the update bit that is associated with the relationship being trained is updated to a logical 1. The training circuitry is configured to determine whether to truncate the training period based on values of the update bits. In particular, the training circuitry is provided with AND circuitry 96. The AND circuitry 96 receives each of the update bits as inputs and determines that the training period should be truncated when all of those update bits are set to a logical 1. The output of the AND circuitry 96 is provided to logical OR circuitry 95 which outputs a signal to trigger the training period to be truncated in response to receipt of a logical 1 from the AND circuitry 96.

The training circuitry is also configured to receive a sequence of operations which are compared against the relationships provided in the training entry 91. The comparison is performed by comparison circuitry 90 which triggers the duration to be incremented for each operation received that does not cause a relationship to be updated. The comparison circuitry 90 is responsive to an operation that causes one of the relationships in the training entry 91 to be updated to trigger that relationship to be updated, to set the update bit associated with that relationship, and to reset the duration in the training entry 91. The training circuitry is configured to truncate the training period when it is determined that the duration indicated in the training entry 91 exceeds a duration threshold 92. The training circuitry is provided with comparison circuitry 93 which receives the duration from the training entry 91 and the duration threshold 92. The comparison circuitry is configured to output a signal to trigger the truncation of the training period when the duration exceeds the duration threshold 92. The signal output from the comparison circuitry 93 is provided to logical OR circuitry 95 which outputs the signal to trigger the training period to be truncated in response to receipt of the signal form the comparison circuitry 93.

The output of the logical OR circuitry 95 is also passed to threshold calculation circuitry 94 which is configured to dynamically update the duration threshold 92. The threshold calculation circuitry also receives information from the comparison circuitry 90 indicating when there is a training match for the training entry 91 along with information indicating whether the update bit has been set for each of the plurality of entries. The threshold calculation circuitry updates the duration threshold based on the average number of relationships updated for the training entry 91 during the training period.

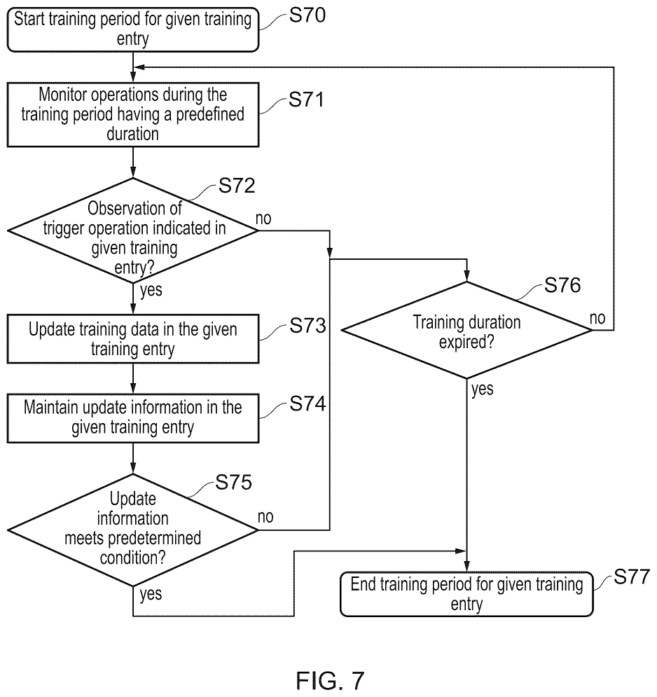

FIG. 7 schematically illustrates a sequence of steps carried out according to some configurations of the present techniques. Flow begins at step S70 where a training period is started for a given training entry. Flow then proceeds to step S71 where operations are monitored during the training period. The training period has a predefined duration measured in terms of the monitored operations. Flow then proceeds to step S72 where it is determined if a trigger operation indicated in the given training entry is observed as one of the monitored operations. If, at step S72, it is determined that there was no observation of a trigger operation indicated in the given training entry, then flow proceeds to step S76. If, at step S72, it is determined that a trigger operation indicated in a given training entry is observed, then flow proceeds to step S73 where the training data in the given training entry is updated. Flow then proceeds to step S74 where update information stored in the given training entry is maintained. Flow then proceeds to step S75 where it is determined if the update information meets a predetermined condition. If, at step S75, it is determined that the update information meets a predetermined condition, then flow proceeds to step S77 where the training period is ended for the given training entry. If, at step S75, it was determined that the update information does not meet the predetermined condition, then flow proceeds to step S76. At step S76 it is determined if the training duration has expired. If, at step S76, it is determined that the training duration has expired, then flow proceeds to step S77 where the training period is ended for the given training entry. If, at step S76, it is determined that the training period has not expired, then flow returns to step S71.

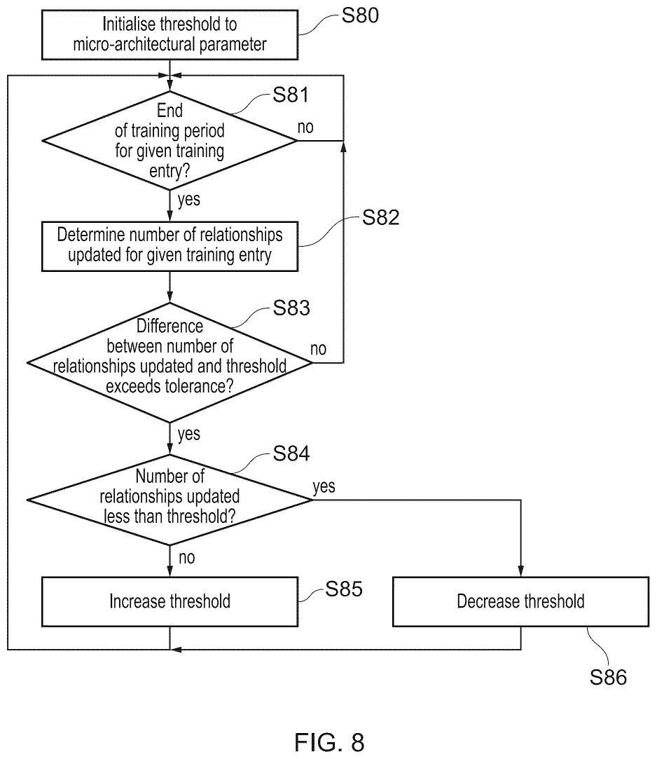

FIG. 8 schematically illustrates a sequence of steps carried out according to some configurations of the present techniques. Flow begins at step S80 where a threshold is initialised to a micro-architectural parameter. Flow then proceeds to step S81 where it is determined if a training period has ended for a given training entry. If, at step S81, it is determined that a training period has not ended for the given training entry then flow remains at step S81. If, at step S81, it is determined that the training period has ended for the given entry, then flow proceeds to step S82 where a number of relationships updated for the given entry are determined. Flow then proceeds to step S83. At step S83 it is determined if a difference between a number of relationships updated and the threshold exceeds a tolerance. If, at step S83, it is determined that the difference between the number of relationships updated and the threshold does not exceed the tolerance, then flow returns to step S81. If, at step S83, it is determined that the difference between the number of relationships updated and the threshold does exceed the tolerance, then flow proceeds to step S84. At step S84, it is determined if the number of relationships updated is less than the threshold. If, at step S84, it is determined that the number of relationships updated is less than the threshold, then flow proceeds to step S86 where the threshold is decreased before flow returns to step S81. If, at step S84, it is determined that the number of relationships updated is not less than the threshold, then flow proceeds to step S85 where the threshold is increased before flow returns to step S81.

Concepts described herein may be embodied in a system comprising at least one packaged chip. The apparatus described earlier is implemented in the at least one packaged chip (either being implemented in one specific chip of the system, or distributed over more than one packaged chip). The at least one packaged chip is assembled on a board with at least one system component. A chip-containing product may comprise the system assembled on a further board with at least one other product component. The system or the chip-containing product may be assembled into a housing or onto a structural support (such as a frame or blade).

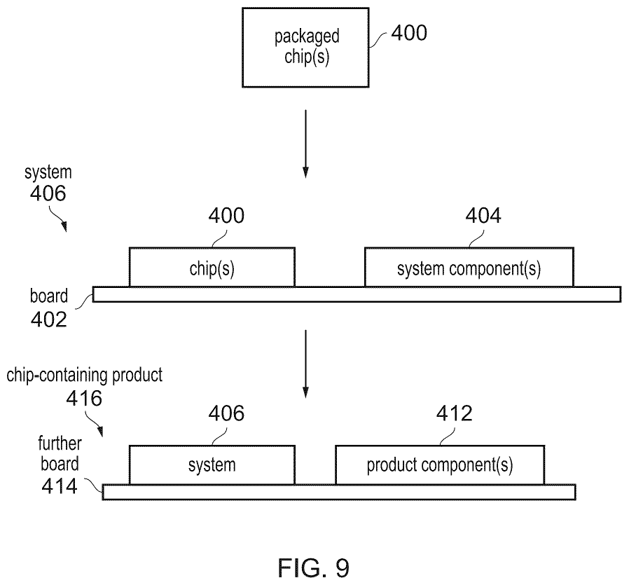

As shown in FIG. 9, one or more packaged chips 400, with the apparatus described above implemented on one chip or distributed over two or more of the chips, are manufactured by a semiconductor chip manufacturer. In some examples, the chip product 400 made by the semiconductor chip manufacturer may be provided as a semiconductor package which comprises a protective casing (e.g. made of metal, plastic, glass or ceramic) containing the semiconductor devices implementing the apparatus described above and connectors, such as lands, balls or pins, for connecting the semiconductor devices to an external environment. Where more than one chip 400 is provided, these could be provided as separate integrated circuits (provided as separate packages), or could be packaged by the semiconductor provider into a multi-chip semiconductor package (e.g. using an interposer, or by using three-dimensional integration to provide a multi-layer chip product comprising two or more vertically stacked integrated circuit layers).

In some examples, a collection of chiplets (i.e. small modular chips with particular functionality) may itself be referred to as a chip. A chiplet may be packaged individually in a semiconductor package and/or together with other chiplets into a multi-chiplet semiconductor package (e.g. using an interposer, or by using three-dimensional integration to provide a multi-layer chiplet product comprising two or more vertically stacked integrated circuit layers).

The one or more packaged chips 400 are assembled on a board 402 together with at least one system component 404 to provide a system 406. For example, the board may comprise a printed circuit board. The board substrate may be made of any of a variety of materials, e.g. plastic, glass, ceramic, or a flexible substrate material such as paper, plastic or textile material. The at least one system component 404 comprise one or more external components which are not part of the one or more packaged chip(s) 400. For example, the at least one system component 404 could include, for example, any one or more of the following: another packaged chip (e.g. provided by a different manufacturer or produced on a different process node), an interface module, a resistor, a capacitor, an inductor, a transformer, a diode, a transistor and/or a sensor.

A chip-containing product 416 is manufactured comprising the system 406 (including the board 402, the one or more chips 400 and the at least one system component 404) and one or more product components 412. The product components 412 comprise one or more further components which are not part of the system 406. As a non-exhaustive list of examples, the one or more product components 412 could include a user input/output device such as a keypad, touch screen, microphone, loudspeaker, display screen, haptic device, etc.; a wireless communication transmitter/receiver; a sensor; an actuator for actuating mechanical motion; a thermal control device; a further packaged chip; an interface module; a resistor; a capacitor; an inductor; a transformer; a diode; and/or a transistor. The system 406 and one or more product components 412 may be assembled on to a further board 414.

The board 402 or the further board 414 may be provided on or within a device housing or other structural support (e.g. a frame or blade) to provide a product which can be handled by a user and/or is intended for operational use by a person or company. The system 406 or the chip-containing product 416 may be at least one of: an end-user product, a machine, a medical device, a computing or telecommunications infrastructure product, or an automation control system. For example, as a non-exhaustive list of examples, the chip-containing product could be any of the following: a telecommunications device, a mobile phone, a tablet, a laptop, a computer, a server (e.g. a rack server or blade server), an infrastructure device, networking equipment, a vehicle or other automotive product, industrial machinery, consumer device, smart card, credit card, smart glasses, avionics device, robotics device, camera, television, smart television, DVD players, set top box, wearable device, domestic appliance, smart meter, medical device, heating/lighting control device, sensor, and/or a control system for controlling public infrastructure equipment such as smart motorway or traffic lights.

Concepts described herein may be embodied in computer-readable code for fabrication of an apparatus that embodies the described concepts. For example, the computer-readable code can be used at one or more stages of a semiconductor design and fabrication process, including an electronic design automation (EDA) stage, to fabricate an integrated circuit comprising the apparatus embodying the concepts. The above computer-readable code may additionally or alternatively enable the definition, modelling, simulation, verification and/or testing of an apparatus embodying the concepts described herein.

For example, the computer-readable code for fabrication of an apparatus embodying the concepts described herein can be embodied in code defining a hardware description language (HDL) representation of the concepts. For example, the code may define a register-transfer-level (RTL) abstraction of one or more logic circuits for defining an apparatus embodying the concepts. The code may define a HDL representation of the one or more logic circuits embodying the apparatus in Verilog, System Verilog, Chisel, or VHDL (Very High-Speed Integrated Circuit Hardware Description Language) as well as intermediate representations such as FIRRTL. Computer-readable code may provide definitions embodying the concept using system-level modelling languages such as SystemC and SystemVerilog or other behavioural representations of the concepts that can be interpreted by a computer to enable simulation, functional and/or formal verification, and testing of the concepts.

Additionally or alternatively, the computer-readable code may define a low-level description of integrated circuit components that embody concepts described herein, such as one or more netlists or integrated circuit layout definitions, including representations such as GDSII. The one or more netlists or other computer-readable representation of integrated circuit components may be generated by applying one or more logic synthesis processes to an RTL representation to generate definitions for use in fabrication of an apparatus embodying the invention. Alternatively or additionally, the one or more logic synthesis processes can generate from the computer-readable code a bitstream to be loaded into a field programmable gate array (FPGA) to configure the FPGA to embody the described concepts. The FPGA may be deployed for the purposes of verification and test of the concepts prior to fabrication in an integrated circuit or the FPGA may be deployed in a product directly.

The computer-readable code may comprise a mix of code representations for fabrication of an apparatus, for example including a mix of one or more of an RTL representation, a netlist representation, or another computer-readable definition to be used in a semiconductor design and fabrication process to fabricate an apparatus embodying the invention. Alternatively or additionally, the concept may be defined in a combination of a computer-readable definition to be used in a semiconductor design and fabrication process to fabricate an apparatus and computer-readable code defining instructions which are to be executed by the defined apparatus once fabricated.

Such computer-readable code can be disposed in any known transitory computer-readable medium (such as wired or wireless transmission of code over a network) or non-transitory computer-readable medium such as semiconductor, magnetic disk, or optical disc. An integrated circuit fabricated using the computer-readable code may comprise components such as one or more of a central processing unit, graphics processing unit, neural processing unit, digital signal processor or other components that individually or collectively embody the concept.

In brief overall summary there is provided an apparatus, a system, a chip containing product, a method, and a computer-readable medium. The apparatus comprises training storage circuitry to store training entries, each comprising training data indicative of a trigger operation and one or more relationships between the trigger operation and operations observed subsequent to the trigger operation. The apparatus comprises training circuitry to monitor operations during a training period having a predefined training duration, and responsive to observation of the trigger operation indicated in a training entry, to update the training data in the training entry. The training storage circuitry is configured to maintain update information associated with each training entry indicating whether that training entry has been updated during the training period. The training circuitry is responsive to a determination that the update information for a given training entry meets a predetermined condition, to truncate the training period for the given training entry.

In the present application, the words “configured to . . . ” are used to mean that an element of an apparatus has a configuration able to carry out the defined operation. In this context, a “configuration” means an arrangement or manner of interconnection of hardware or software. For example, the apparatus may have dedicated hardware which provides the defined operation, or a processor or other processing device may be programmed to perform the function. “Configured to” does not imply that the apparatus element needs to be changed in any way in order to provide the defined operation.

In the present application, lists of features preceded with the phrase “at least one of” mean that any one or more of those features can be provided either individually or in combination. For example, “at least one of: [A], [B] and [C]” encompasses any of the following options: A alone (without B or C), B alone (without A or C), C alone (without A or B), A and B in combination (without C), A and C in combination (without B), B and C in combination (without A), or A, B and C in combination.

Although illustrative configurations of the invention have been described in detail herein with reference to the accompanying drawings, it is to be understood that the invention is not limited to those precise configurations, and that various changes, additions and modifications can be effected therein by one skilled in the art without departing from the scope of the invention as defined by the appended claims. For example, various combinations of the features of the dependent claims could be made with the features of the independent claims without departing from the scope of the present invention.

Some configurations of the present techniques are described by the following numbered clauses:

Clause 1. An apparatus comprising:
training storage circuitry configured to store one or more training entries, each of the one or more training entries comprising training data indicative of a trigger operation and one or more relationships between the trigger operation and operations observed subsequent to the trigger operation, wherein the training data is suitable to be used for generation of speculative operations by a predictive structure in response to observation of the trigger operation; and
training circuitry configured to monitor operations during a training period having a predefined training duration, and responsive to observation of the trigger operation indicated in a training entry of the one or more training entries, to update the training data in the training entry based on the monitored operations,
wherein:
the training storage circuitry is configured to maintain update information associated with each one of the one or more training entries and indicative of whether that one of the one or more training entries has been updated during the training period; and
the training circuitry is responsive to a determination that the update information associated with a given training entry of the one or more training entries meets a predetermined condition, to truncate the training period for the given training entry.
   Clause 2. The apparatus of clause 1, wherein the update information comprises, for each one of the one or more training entries, an update indication identifying which of the one or more relationships indicated in that one of the one or more training entries have been updated during the training period.
   Clause 3. The apparatus of clause 2, wherein the predetermined condition is met for the given training entry when the update information for the given training entry indicates that a predetermined number of the one or more relationships indicated in the given training entry have been updated during the training period.
   Clause 4. The apparatus of clause 2 or clause 3, wherein the update indication is encoded as an additional bit for each of the one or more relationships.
   Clause 5. The apparatus of any preceding clause, wherein the update information comprises, for each one of the one or more training entries, update duration information indicative of a duration since a last update to one of the one or more relationships indicated in that one of the one or more training entries.
   Clause 6. The apparatus of clause 5, wherein for each of the one or more training entries the update duration information is encoded in a counter associated with that one of the one or more training entries.
   Clause 7. The apparatus of clause 5 or clause 6, wherein the predetermined condition is met for the given training entry when the duration information meets or exceeds a duration threshold.
   Clause 8. The apparatus of clause 7, wherein the duration threshold is a global threshold that is common to the one or more training entries.
   Clause 9. The apparatus of clause 7 or clause 8, wherein the duration threshold is modified in response to the predetermined condition being met.
   Clause 10. The apparatus of any of clauses 7 to 9, wherein the duration threshold is updated based on an average number of relationships updated for each of the one or more training entries during the training period.
   Clause 11. The apparatus of any of clauses 7 to 10, wherein the duration threshold is initialised based on a micro-architectural parameter.
   Clause 12. The apparatus of any preceding clause, wherein the trigger operation is a memory access operation and each of the one or more operations observed subsequent to the trigger operations are subsequent memory access operations.
   Clause 13. The apparatus of any preceding clause, wherein the predictive structure is a prefetching structure.
   Clause 14. The apparatus of any preceding clause, comprising pattern history table storage circuitry configured to store a pattern history table, the pattern history table comprising a plurality of entries,
wherein:
the predictive structure is configured to generate the speculative operations based on at least one of the plurality of entries; and
the training circuitry is configured to select one or more entries from amongst the plurality of entries to be stored in the training storage circuitry as the one or more training entries during each of a plurality of training periods.
   Clause 15. The apparatus of any preceding clause, wherein the predefined training duration is defined in terms of a number of monitored operations.
   Clause 16. The apparatus of any preceding clause, wherein updating the training data comprises at least one of:
updating a confidence associated with one of the one or more relationships based on the operations observed subsequent to the trigger operation; and
allocating a new relationship based on the operations observed subsequent to the trigger operation.
   Clause 17. A system comprising:
the apparatus of any preceding clause, implemented in at least one packaged chip;
at least one system component; and
a board,
wherein the at least one packaged chip and the at least one system component are assembled on the board.
   Clause 18. A chip-containing product comprising the system of clause 17, wherein the system is assembled on a further board with at least one other product component.
   Clause 19. A method comprising:
storing one or more training entries, each of the one or more training entries comprising training data indicative of a trigger operation and one or more relationships between the trigger operation and operations observed subsequent to the trigger operation, wherein the training data is suitable to be used for generation of speculative operations by a predictive structure in response to observation of the trigger operation;
monitoring operations during a training period having a predefined training duration, and in response to observation of the trigger operation indicated in a training entry of the one or more training entries, updating the training data in the training entry based on the monitored operations;
maintaining update information associated with each one of the one or more training entries and indicative of whether that one of the one or more training entries has been updated during the training period; and
in response to a determination that the update information associated with a given training entry of the one or more training entries meets a predetermined condition, truncating the training period for the given training entry.
   Clause 20. A non-transitory computer-readable medium storing computer-readable code for fabrication of the apparatus of any of clauses 1 to 16.

We claim:

1. An apparatus comprising:
training storage circuitry configured to store one or more training entries, each of the one or more training entries comprising training data indicative of a trigger operation and one or more relationships between the trigger operation and operations observed subsequent to the trigger operation, wherein the training data is suitable to be used for generation of speculative operations by a predictive structure in response to observation of the trigger operation; and
training circuitry configured to monitor operations during a training period having a predefined training duration, and responsive to observation of the trigger operation indicated in a training entry of the one or more training entries, to update the training data in the training entry based on the monitored operations,
wherein:
the training storage circuitry is configured to maintain update information associated with each one of the one or more training entries and indicative of whether that one of the one or more training entries has been updated during the training period; and
the training circuitry is responsive to a determination that the update information associated with a given training entry of the one or more training entries meets a predetermined condition, to truncate the training period for the given training entry.

2. The apparatus of claim 1, wherein the update information comprises, for each one of the one or more training entries, an update indication identifying which of the one or more relationships indicated in that one of the one or more training entries have been updated during the training period.

3. The apparatus of claim 2, wherein the predetermined condition is met for the given training entry when the update information for the given training entry indicates that a predetermined number of the one or more relationships indicated in the given training entry have been updated during the training period.

4. The apparatus of claim 2, wherein the update indication is encoded as an additional bit for each of the one or more relationships.

5. The apparatus of claim 1, wherein the update information comprises, for each one of the one or more training entries, update duration information indicative of a duration since a last update to one of the one or more relationships indicated in that one of the one or more training entries.

6. The apparatus of claim 5, wherein for each of the one or more training entries the update duration information is encoded in a counter associated with that one of the one or more training entries.

7. The apparatus of claim 5, wherein the predetermined condition is met for the given training entry when the duration information meets or exceeds a duration threshold.

8. The apparatus of claim 7, wherein the duration threshold is a global threshold that is common to the one or more training entries.

9. The apparatus of claim 7, wherein the duration threshold is modified in response to the predetermined condition being met.

10. The apparatus of claim 7, wherein the duration threshold is updated based on an average number of relationships updated for each of the one or more training entries during the training period.

11. The apparatus of claim 7, wherein the duration threshold is initialised based on a micro-architectural parameter.

12. The apparatus of claim 1, wherein the trigger operation is a memory access operation and each of the one or more operations observed subsequent to the trigger operations are subsequent memory access operations.

13. The apparatus of claim 1, wherein the predictive structure is a prefetching structure.

14. The apparatus of claim 1, comprising pattern history table storage circuitry configured to store a pattern history table, the pattern history table comprising a plurality of entries,
wherein:
the predictive structure is configured to generate the speculative operations based on at least one of the plurality of entries; and
the training circuitry is configured to select one or more entries from amongst the plurality of entries to be stored in the training storage circuitry as the one or more training entries during each of a plurality of training periods.

15. The apparatus of claim 1, wherein the predefined training duration is defined in terms of a number of monitored operations.

16. The apparatus of claim 1, wherein updating the training data comprises at least one of:
updating a confidence associated with one of the one or more relationships based on the operations observed subsequent to the trigger operation; and
allocating a new relationship based on the operations observed subsequent to the trigger operation.

17. A system comprising:
the apparatus of claim 1, implemented in at least one packaged chip;
at least one system component; and
a board,
wherein the at least one packaged chip and the at least one system component are assembled on the board.

18. A chip-containing product comprising the system of claim 17, wherein the system is assembled on a further board with at least one other product component.

19. A method comprising:
storing one or more training entries, each of the one or more training entries comprising training data indicative of a trigger operation and one or more relationships between the trigger operation and operations observed subsequent to the trigger operation, wherein the training data is suitable to be used for generation of speculative operations by a predictive structure in response to observation of the trigger operation;
monitoring operations during a training period having a predefined training duration, and in response to observation of the trigger operation indicated in a training entry of the one or more training entries, updating the training data in the training entry based on the monitored operations;
maintaining update information associated with each one of the one or more training entries and indicative of whether that one of the one or more training entries has been updated during the training period; and
in response to a determination that the update information associated with a given training entry of the one or more training entries meets a predetermined condition, truncating the training period for the given training entry.

20. A non-transitory computer-readable medium storing computer-readable code for fabrication of an apparatus comprising:
training storage circuitry configured to store one or more training entries, each of the one or more training entries comprising training data indicative of a trigger operation and one or more relationships between the trigger operation and operations observed subsequent to the trigger operation, wherein the training data is suitable to be used for generation of speculative operations by a predictive structure in response to observation of the trigger operation; and
training circuitry configured to monitor operations during a training period having a predefined training duration, and responsive to observation of the trigger operation indicated in a training entry of the one or more training entries, to update the training data in the training entry based on the monitored operations,
wherein:
the training storage circuitry is configured to maintain update information associated with each one of the one or more training entries and indicative of whether that one of the one or more training entries has been updated during the training period; and
the training circuitry is responsive to a determination that the update information associated with a given training entry of the one or more training entries meets a predetermined condition, to truncate the training period for the given training entry.
